(19) United States
(12) Patent Application Publication
(10) Pub. No.: US 2017/0300945 A1
(43) Pub. Date: Oct. 19, 2017

(54) SEGMENTING MOBILE SHOPPERS

(71) Applicant: International Business Machines Corporation, Armonk, NY (US)

(72) Inventor: Leho Nigul, Richmond Hill (CA)

(21) Appl. No.: 15/099,652

(22) Filed: Apr. 15, 2016

(51) Int. Cl. G06Q 30/02; H04N 7/18; H04W 12/08; G06K 9/46

(52) U.S. Cl. CPC G06Q 30/0204; H04W 12/08; G06K 9/46; G06Q 30/0254; H04N 7/185

(57) ABSTRACT

In one embodiment, a method for segmenting mobile shoppers using image and camera stream recognition is provided. The method includes receiving authorization from a mobile user to access one or more images and/or videos on a mobile device. The method further includes receiving image data including at least one of the one or more images and/or videos on the mobile device. The method further includes analyzing the image data using one or more image and/or video analyzers to identify a set of characteristics associated with the mobile user. The method further includes associating the mobile user with one or more marketing segments based, at least in part, on the identified set of characteristics and sending data associating the mobile user with the one or more marketing segments to an ecommerce retailer.

### BACKGROUND

The present invention relates generally to the field of e-commerce, and more particularly to segmenting mobile shoppers using image and camera stream recognition.

Electronic commerce, also referred to as e-commerce, is the trading or facilitation of trading in products or services using computer networks, such as the Internet. Electronic commerce draws on technologies such as mobile commerce, electronic funds transfer, supply chain management, Internet marketing, online transaction processing, electronic data interchange (EDI), inventory management systems, and automated data collection systems. Modern electronic commerce typically uses the World Wide Web for at least one part of the transaction's life cycle, although it may also use other technologies such as e-mail.

Consumer segmentation, also referred to as client segmentation, is the practice of dividing a customer base into groups of individuals that are similar in specific ways relevant to marketing, such as age, gender, interests and spending habits.

Image analysis is the extraction of meaningful information from images, mainly from digital images by means of digital image processing techniques.

Precision marketing is a marketing technique that suggests successful marketing is to retain, cross-sell and upsell existing customers. Precision marketers typically solicit personal preferences directly from customers by collecting and analyzing personal, behavioral, and transactional data.

### SUMMARY

Embodiments of the present invention disclose a method, computer program product, and system for segmenting mobile shoppers using image and camera stream recognition. The method includes receiving authorization from a mobile user to access one or more images and/or videos on a mobile device. The method further includes receiving image data including at least one of the one or more images and/or videos on the mobile device. The method further includes analyzing the image data using one or more image and/or video analyzers to identify a set of characteristics associated with the mobile user. The method further includes associating the mobile user with one or more marketing segments based, at least in part, on the identified set of characteristics and sending data associating the mobile user with the one or more marketing segments to an ecommerce retailer.

### BRIEF DESCRIPTION OF THE DRAWINGS

FIG. 1 is a functional block diagram illustrating a mobile computing environment, in an embodiment in accordance with the present invention.

FIG. 2 is a flowchart depicting operational steps of an image/video analyzer, on a mobile device within the mobile computing environment of FIG. 1, for determining one or more market segments for a user of the mobile device, in an embodiment in accordance with the present invention.

FIG. 3 is a flowchart depicting operational steps of a segmentation engine, on a server within the mobile computing environment of FIG. 1, for associating a user of a mobile device with one or more defined market segments, in an embodiment in accordance with the present invention.

FIG. 4 is a flowchart depicting operational steps of a process for segmenting mobile shoppers using image and camera stream recognition, in an embodiment in accordance with the present invention.

FIG. 5 depicts a block diagram of components of the server executing the segmentation engine, in an embodiment in accordance with the present invention.

### DETAILED DESCRIPTION

Embodiments in accordance with the present invention recognize that with the current proliferation of mobile shopping, ecommerce merchants may have an access to a mobile device camera and, with permission of a user, access to images and videos stored on the mobile device. Therefore, a camera feed, images, and/or videos may be analyzed to provide information that may enable ecommerce retailers to provide a more personalized customer segmentation.

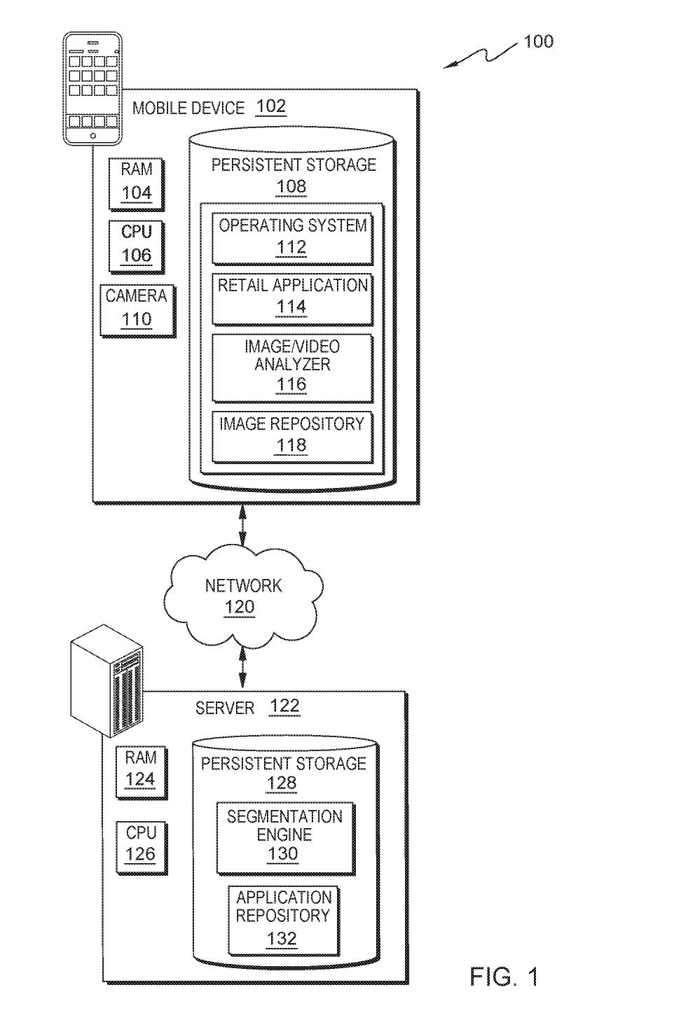

Embodiments in accordance with the present invention will now be described in detail with reference to the Figures. FIG. 1 is a functional block diagram, generally designated 100, illustrating a mobile computing environment, in an embodiment in accordance with the present invention.

Mobile computing environment 100 includes mobile device 102, server 122, and other computing devices (not shown), all interconnected over network 120. Mobile device 102 includes random access memory (RAM) 104, central processing unit (CPU) 106, persistent storage 108 and camera 110. Mobile device 102 may be a Web server, or any other electronic device or computing system, capable of processing program instructions and receiving and sending data. In some embodiments, mobile device 102 may be a laptop computer, a tablet computer, a netbook computer, a personal computer (PC), a desktop computer, a personal digital assistant (PDA), a smart phone, or any programmable electronic device capable of communicating over a data connection to network 120. In other embodiments, mobile device 102 may represent server computing systems utilizing multiple computers as a server system, such as in a distributed computing environment. In general, mobile device 102 is representative of any electronic device or combinations of electronic devices capable of executing machine-readable program instructions and communicating with server 122 via network 120 and with various components and devices (not shown) within mobile computing environment 100.

Mobile device 102 includes persistent storage 108. Persistent storage 108 may, for example, be a hard disk drive. Alternatively, or in addition to a magnetic hard disk drive, persistent storage 108 may include a solid state hard drive, a semiconductor storage device, read-only memory (ROM), erasable programmable read-only memory (EPROM), flash memory, or any other computer-readable storage medium that is capable of storing program instructions or digital information. Persistent storage 108 also includes operating system 112 that allows mobile device 102 to communicate with server 122 and other computing devices (not shown) of mobile computing environment 100 over a data connection on network 120. Retail application 114, image/video analyzer 116, and image repository 118 are also stored in persistent storage 108. In other example embodiments, retail application 114, image/video analyzer 116, and image repository 118 may be components of an operating system 112.

Retail application 114 is a computer program, or set of computer programs, that is stored in persistent storage 108. In one example embodiment, retail application 114 is a mobile application designed to run on mobile devices such as smartphones and tablet computers (e.g., mobile device 102). In another example embodiments, retail application 114 may be bundled as part of pre-installed software, such as a web browser, email client, calendar, or a mapping program on mobile device 102. In another example embodiment, retail application 114 may be downloaded from server 122 or from a third party vendor (not shown) over a data connection on network 120. Retail application 114, as a pre-installed application or downloaded application, may be removed by an ordinary uninstall process. Retail application 114 allows a user of mobile device 102 to experience a more personalized experience to online shopping by allowing retail application 114 to search and purchase products at ecommerce retailers. For example, a user of mobile device 102 may download an ecommerce application, such as retail application 114, from an ecommerce retailer mobile website (e.g., hosted on server 122 and application repository 132). Upon downloading retail application 114, the user may search for, and purchase, one or more specific products. In one embodiment, retail application 114 may request access to one or more pictures and videos in image repository 118 of mobile device 102 as part of a process of segmenting the user of mobile device 102 into one or more targeted consumer segments.

Image/video analyzer 116 is a computer program, or set of computer programs, that is stored in persistent storage 108. Image/video analyzer 116 is used by retail application 114 to analyze one or more images and/or videos in image repository 118s. In one example embodiment, image/video analyzer 116 may use one or more image and video recognition analyzers to identify a set of characteristics associated with the user of mobile device 102 when a new image and/or video is captured with camera 110. In another example embodiment, image/video analyzer 116 may use one or more image and video recognition analyzers to identify a set of characteristics associated with the user of mobile device 102 at scheduled intervals defined by an ecommerce retailer. In other example embodiments, image/video analyzer 116 may be included as one or more software components of retail application 114.

In certain embodiments, image/video analyzer 116, upon identifying a set of characteristics associated with the user of mobile device 102, classifies the user of mobile device 102 into one or more defined market segments based on those identified characteristics. In other embodiments, this classification is performed by segmentation engine 130 on server 122 (which will be discussed in further detail below). In still other embodiments, image/video analyzer 116 performs an initial analysis of one or more images and/or videos in image repository 118, and then sends that analysis to segmentation engine 130 for identification of characteristics and/or classification into market segments.

Image repository 118 is a computer program, or set of computer programs, that is stored in persistent storage 108. Image repository 118 enables a user to store one or more images and/or videos captured by camera 110 to be analyzed by image/video analyzer 116 at a later time. In other example embodiments, image repository 118 may be located on one or more other computing devices of mobile computing environment 100. For example, image repository 118 may be an image repository in a cloud computing environment.

Mobile device 102 includes camera 110. Camera 110 is an optical instrument for recording images that may be stored locally in image repository 118, and/or transmitted to another location, such as server 122 or another device (not shown) within mobile computing environment 100. Images captured, by a user or one or more executing applications (e.g., retail application 114) of mobile device 102, may be individual still photographs or sequences of images constituting videos or movies.

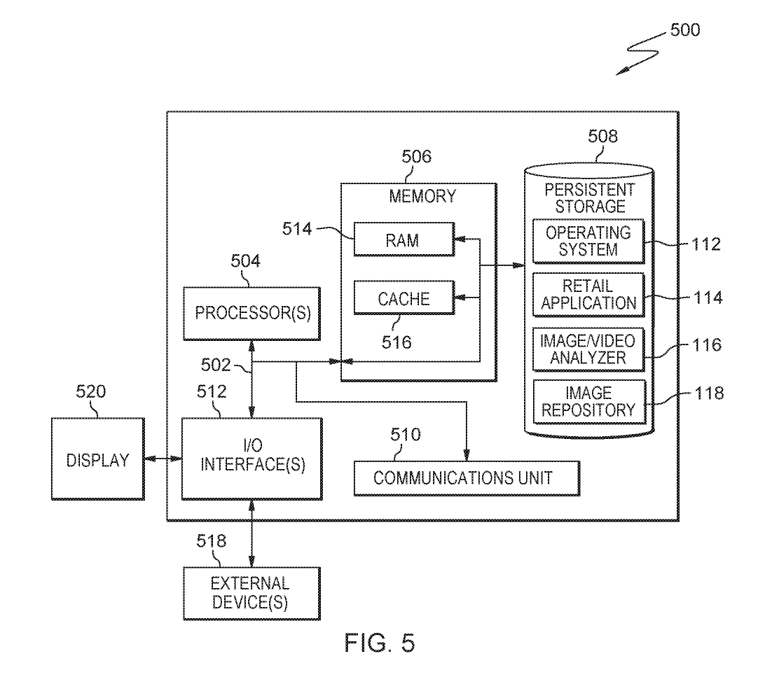

Mobile device 102 may include internal and external hardware components, as depicted and described in further detail with respect to FIG. 5.

In FIG. 1, network 120 is shown as the interconnecting fabric between mobile device 102, server 122, and with various components and devices (not shown) within mobile computing environment 100. In practice, the connection may be any viable data transport network, such as, for example, a LAN or WAN. Network 120 can be for example, a local area network (LAN), a wide area network (WAN) such as the Internet, or a combination of the two, and include wired, wireless, or fiber optic connections. In general, network 120 can be any combination of connections and protocols that will support communications between mobile device 102, server 122, and with various components and devices (not shown) within mobile computing environment 100.

Server 122 is included in mobile computing environment 100. Server 122 includes random access memory (RAM) 124, central processing unit (CPU) 126, and persistent storage 128. Server 122 may be a Web server, or any other electronic device or computing system, capable of processing program instructions and receiving and sending data. In some embodiments, server 122 may be a laptop computer, a tablet computer, a netbook computer, a personal computer (PC), a desktop computer, a personal digital assistant (PDA), a smart phone, or any programmable electronic device capable of communicating over a data connection to network 120. In other embodiments, server 122 may represent server computing systems utilizing multiple computers as a server system, such as in a distributed computing environment. In general, server 122 is representative of any electronic devices or combinations of electronic devices capable of executing machine-readable program instructions and communicating with mobile device 102 via network 120 and with various components and devices (not shown) within mobile computing environment 100.

Server 122 includes persistent storage 128. Persistent storage 128 may, for example, be a hard disk drive. Alternatively, or in addition to a magnetic hard disk drive, persistent storage 128 may include a solid state hard drive, a semiconductor storage device, read-only memory (ROM), erasable programmable read-only memory (EPROM), flash memory, or any other computer-readable storage medium that is capable of storing program instructions or digital information. Segmentation engine 130 and application repository 132 are stored in persistent storage 128, which also includes operating system software, as well as software that enables server 122 to detect and establish a connection to mobile device 102, and communicate with other computing devices (not shown) of mobile computing environment 100 over a data connection on network 120.

Segmentation engine 130 is a computer program, or sets of computer programs, that are stored in persistent storage 128. Segmentation engine 130 receives a set of characteristics associated with a user of mobile device 102 from image/video analyzer 116. Upon receiving the set of characteristics associated with the user of mobile device 102, segmentation engine 130 uses the characteristics to associate the user of mobile device 102 with one or more predefined marketing segments and sends the data to an ecommerce retailer. In one example embodiment, image/video analyzer 116 and segmentation engine 130 may be contained together in server 122 or separately in a plurality of computing devices (not shown) within mobile computing environment 100. Further, in certain embodiments, segmentation engine 130, prior to associating the user of mobile device 102 with one or more predefined marketing segments based on the set of characteristics, also identifies the set of characteristics based on an initial analysis performed by image/video analyzer 116 and received from mobile device 102. Application repository 132 is a computer program, or set of computer programs, that is stored in persistent storage 128. Application repository 132 is a software repository that may store one or more software packages, such as retail application 114, which may be downloaded and installed by a user on a computing device, such as mobile device 102.

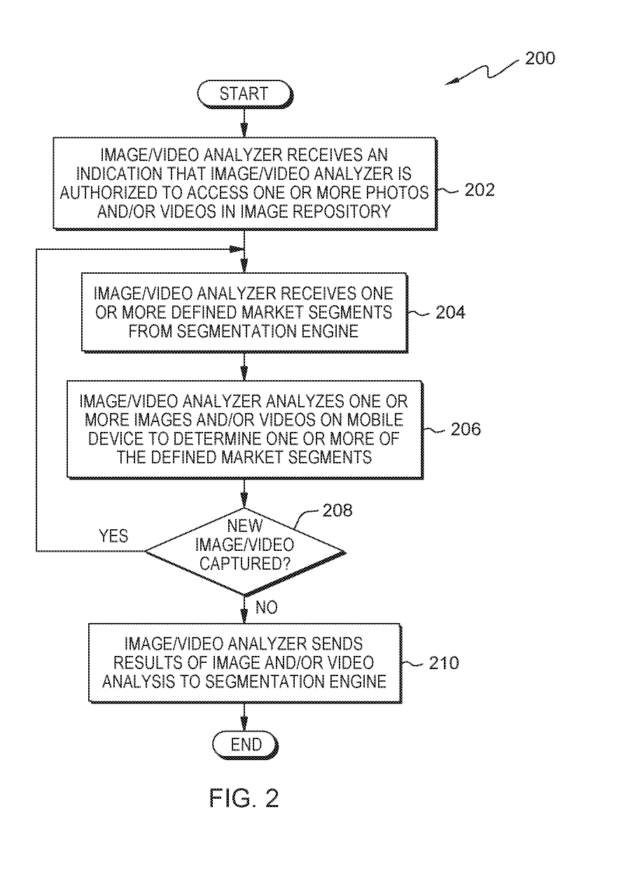

FIG. 2 is a flowchart, generally designated 200, depicting operational steps of an image/video analyzer, on a mobile device within the mobile computing environment of FIG. 1, for determining one or more market segments for a user of the mobile device, in an embodiment in accordance with the present invention. In an example embodiment, a user of mobile device 102 downloads retail application 114 from persistent storage 128 on server 122 over a data connection on network 120 to perform one or more ecommerce operations. For example, the user of mobile device 102 may use retail application 114 to perform, for example, one or more of the following operations: (i) search for one or more products, (ii) track the status of one or more purchases, (iii) pay a balance for a recent purchase on an ecommerce store credit card, (iv) determine a store location and/or store hours, and (v) contact a customer service representative via email, phone, fax, and/or text message.

Image/video analyzer 116 receives an indication that image/video analyzer 116 is authorized to access one or more photos and/or videos in image repository 118 of mobile device 102 as depicted in step 202. For example, upon executing retail application 114, the user of mobile device 102 is prompted to authorize retail application 114's access to image repository 118. In another example embodiment, the user of mobile device 102 may be prompted to authorize retail application 114's access to an image repository in a cloud environment.

In step 204, image/video analyzer 116 receives one or more defined market segments from segmentation engine 130. For example, prior to analyzing the one or more photos and/or videos in image repository 118, image/video analyzer 116 may determine if one or more defined market segments exist on segmentation engine 130. The received market segments may include, but are not limited to, the following: (i) one or more age ranges of targeted consumers (for example 18-25), (ii) marital status (for example single or married), (iii) an indoors or outdoors type, (iv) one or more targeted age groups for children (for example newborns, toddlers, juniors, young adults, and adults), (v) one or more style of clothes, and (vi) one or more hobbies.

Image/video analyzer 116 analyzes one or more images and/or videos on mobile device 102 to determine one or more of the defined market segments as depicted in step 206. For example, image/video analyzer 116 may perform an image and/or video analysis on the one or more photos and/or videos in image repository 118 to identify the one or more defined market segments received from segmentation engine 130. For example, upon analyzing one or more images and/or videos in image repository 118, image/video analyzer 116 may determine the user of mobile device 102 is female in her mid-twenties and prefers the color red for athletic apparel. Image/video analyzer 116 may then associate the user of mobile device 102 with the received one or more defined market segments for women in their twenties, and red athletic outdoor apparel. In another example of determining one or more of the defined market segments, upon analyzing one or more images and/or videos in image repository 118, image/video analyzer 116 may determine the user of mobile device 102 is a male in his early twenties and is an avid fly fisherman. Image/video analyzer 116 may then associate the user of mobile device 102 with the received one or more defined market segments for hand-tied fly fishing flies, light weight fly fishing rods, and fly fishing apparel. In another example of determining one or more of the defined market segments, upon analyzing one or more images and/or videos in image repository 118, image/video analyzer 116 may determine the user of mobile device 102 spends a certain amount of time knitting and scrap booking. Image/video analyzer 116 may then associate the user of mobile device 102 with the received one or more defined market segments for arts and crafts.

In decision step 208, image/video analyzer 116 determines if a new image and/or video has been captured on mobile device 102. For example, a user of mobile device 102 captures one or more images and/or videos using camera 110. Image/video analyzer 116 detects the captured one or more images and/or videos in image repository 118. For example, image/video analyzer 116 may periodically check image repository 118 at periodic intervals to determine if there are one or more new images and/or videos. In other example embodiments, the user of mobile device 102 may activate camera 110 via retail application 114. For example, retail application 114 may also request access to one or more social media sites, or cloud storage accounts, and one or more calendar applications and/or functions of mobile device 102. Once access to the cloud storage account is granted, retail application 114 and/or image/video analyzer 116 may determine one or more images and/or videos of the user of mobile device 102 based on, for example, “tag” indications of the one or more images and/or videos. In social media networking, a tag is a link to a user's profile that also serves as an identifier of the user. Tagged photos indicate who is in the photo. Upon determining the user of mobile device 102 is about to attend an event, such as a family reunion and/or barbecue, retail application 114 and/or image/video analyzer 116 may periodically prompt, or recommend, the user to take pictures at the event to automatically post the pictures to the social media site and/or then repeat steps 204 and 206. For example, during the event, retail application 114 and/or image/video analyzer 116 may prompt the user to take a picture and/or video of their favorite food. Or, during the event, retail application 114 and/or image/video analyzer 116 may prompt the user to take a group picture, or a “selfie”, with one or more participants, such as friends and/or family, and tag the user of mobile device 102. In yet another example, retail application 114 and/or image/video analyzer 116 may prompt the user to take one or more pictures and/or videos of one or more products the user owns, or possesses, in a category that the ecommerce retailer sells products in. If image/video analyzer 116 determines that a new image and/or video have been captured (“Yes” branch, decision step 208), image/video analyzer 116 repeats steps 204 and 206 as depicted in FIG. 2. If image/video analyzer 116 determines that no new image and/or video have been captured (“No” branch, decision step 208), image/video analyzer 116 sends the results of the one or more images and/or videos analysis to segmentation engine 130 as depicted in step 210.

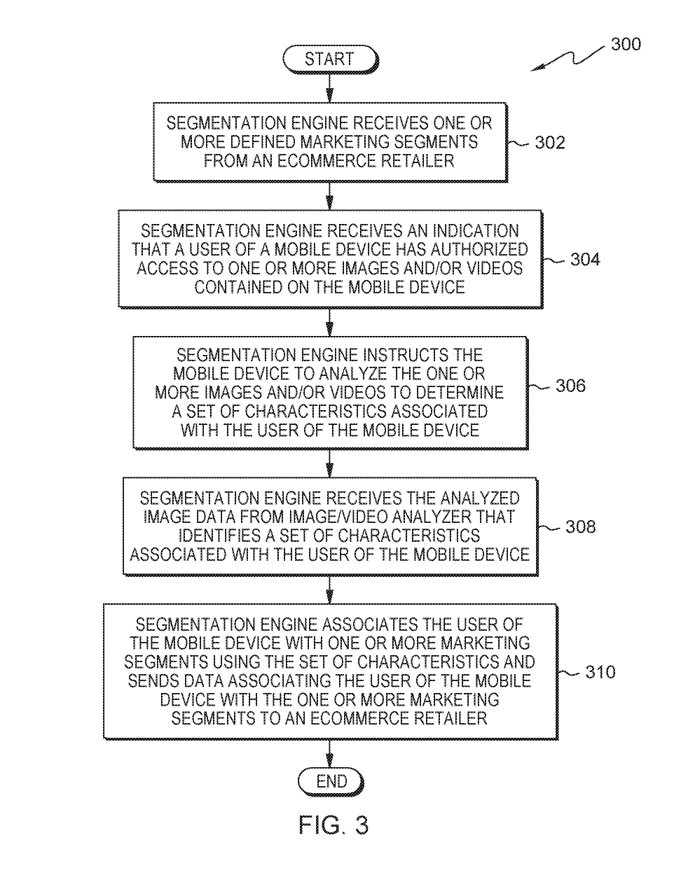

FIG. 3 is a flowchart, generally designated 300, depicting operational steps of a segmentation engine, on a server within the mobile computing environment of FIG. 1, for associating a user of a mobile device with one or more defined market segments, in an embodiment in accordance with the present invention. In an example embodiment, segmentation engine 130 receives one or more defined marketing segments from an ecommerce retailer, wherein the one or more defined marketing segments are defined using one or more market segmentation methods known in the art, as depicted in step 302. For example, an ecommerce retailer may define one or more marketing segments to associate one or more users of retail application 114 with a variety of product, such as outdoor camping gear and accessories.

In step 304, segmentation engine 130 receives an indication that a user of mobile device 102 has authorized access to one or more images and/or videos contained on the mobile device image repository 118. For example, upon downloading and installing retail application 114 from application repository 132, a user is asked to authorize access for retail application 114 to one or more images and/or videos in image repository 118. Upon authorizing retail application 114 to access one or more images and/or videos in image repository 118, retail application 114 may notify segmentation engine 130 of the authorization. In other example embodiments, retail application may begin analyzing the one or more images and/or videos in image repository 118 once authorized rather than notifying segmentation engine 130 of the granted access.

Segmentation Engine 130 instructs mobile device 102 to analyze the one or more images and/or videos to determine a set of characteristics associated with the user of the mobile device as depicted in step 306. For example, upon receiving the authorization for access to the one or more images and/or videos in image repository 118 by retail application 114, segmentation engine 130 may determine an age range the user of mobile device 102 based on one or more images of the user of mobile device 102 at a birthday party. In another example, segmentation engine 130 may determine the user of mobile device 102 is female and has purchased a new home after analyzing one or more images and/or videos of the user of mobile device 102 of a new home. Segmentation engine 130 may also determine a set of characteristics associated with the user of the mobile device where retail application 114 and/or image repository 118 determines that the user of mobile device 102 is an avid gardener and enjoys a certain type of flower based on one or more images of the certain type of flower at the GPS location of the user of mobile device 102. Additionally segmentation engine 130 may determine the user of mobile device 102 is a male in his mid-twenties and is a frequent skier. For example, the analyzed image may be of the user holding a pair of skis. In other example embodiments, segmentation engine 130 may additionally define a schedule to poll retail application 114 and/or image repository 118 during random intervals to determine if one or more new images and/or videos have been captured by camera 110.

In step 308, segmentation engine 130 receives the analyzed image data from image/video analyzer 116 that identifies a set of characteristics associated with the user of the mobile device 102. For example, segmentation engine 130 may receive data from image/video analyzer 116 indicating the user of mobile device is a female in her mid-twenties, who is expecting a child. Additionally the received data may also indicate the user of mobile device wears prescription glasses and/or contact lenses.

Segmentation Engine 130 associates the user of mobile device 102 with one or more marketing segments using the set of characteristics and sends data associating the user of mobile device 102 with the one or more marketing segments to an ecommerce retailer as depicted in step 310. For example, segmentation engine 130 may associate the user of mobile device 102 with one or more specific products that are currently on sale and notify the user of mobile device of the sale for the one or more specific products using emails, a pre-recorded phone message, a facsimile, and/or a text message to mobile device 102. In other example embodiments, segmentation engine 130 may transmit one or more specific advertisements (or “ads”) to retail application 114 and/or display the one or more specific ads using other applications executing on mobile device 102. For example, one or more specific ads may be displayed when the user of mobile device 102 executes a web browser.

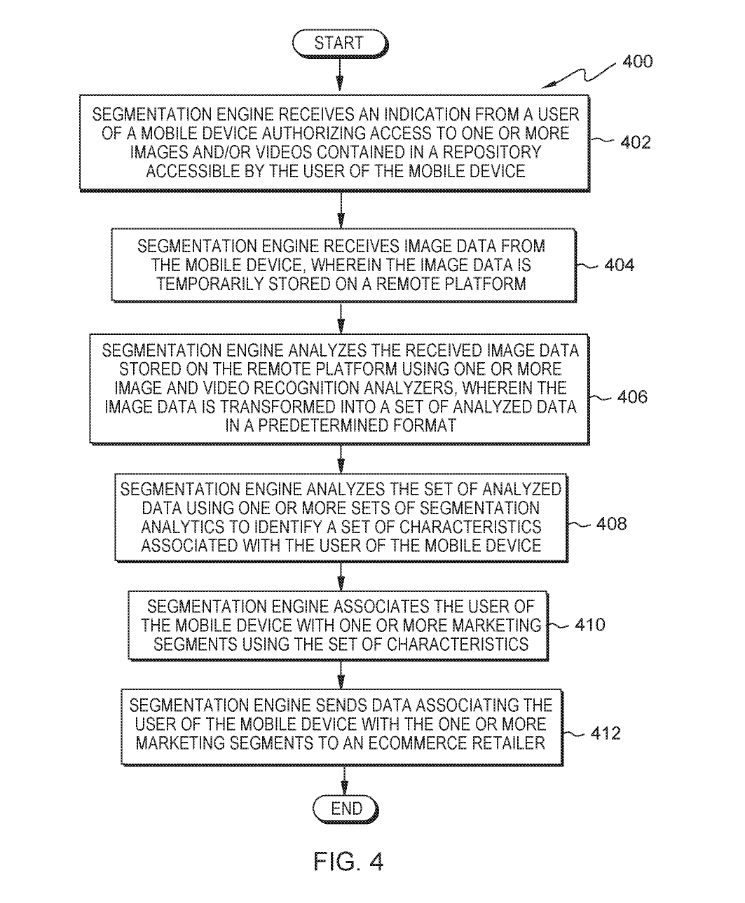

FIG. 4 is a flowchart, generally designated 400, depicting operational steps of a process for segmenting mobile shoppers using image and camera stream recognition, in an embodiment in accordance with the present invention. In an example embodiment, segmentation engine 130 receives an indication from a user of mobile device 102 authorizing access to one or more images and/or videos contained in a repository accessible by the user of the mobile device (e.g., a social media website), as depicted in step 402. For example, segmentation engine 130 may receive an authorization to access one or more images and/or videos contained on a plurality of computing devices and/or repositories within mobile computing environment 100, such as one or more online social media websites or an Internet-based image publishing service. For example, retail application 114 may additionally ask the user to grant access to one the one or more online social media websites or the Internet-based image publishing service. Retail application 114 and/or image/video analyzer 116 may then connect to the one or more online social media websites and/or Internet-based image publishing service to analyze one or more images and/or videos associated with the user of mobile device 102.

In step 404, segmentation engine 130 receives image data from mobile device 102, wherein the image data is temporarily stored on a remote platform. For example, segmentation engine 130 may temporarily, and securely, store the data, also referred to as transitory data, in an encrypted repository (not shown), using methods known to one skilled in the art, to prevent unwanted access to personal information of the user of mobile device 102, the one or more online social media websites, and/or the Internet-based image publishing service. In one example embodiment, the received image data may include global positioning system (GPS) coordinates indicating one or more frequently visited vacation destinations.

Segmentation engine 130 analyzes the received image data stored on the remote platform using one or more image and video recognition analysis analyzers, wherein the image data is transformed into a set of analyzed data in a predetermined format as depicted in step 406. For example, segmentation engine 130 may receive one or more images and/or videos and analyze them using an instance of image/video analyzer 116 to determine one or more defined market segments that are relevant to the ecommerce retailer. In one example embodiment, the received image data stored on the remote platform may contain characteristics such as a determined age range of the user of mobile device 102. The received image data stored on the remote platform may also indicate whether the user of mobile device 102 has one or more children, or whether the user of mobile device 102 is a frequent vacation traveler.

In step 408, segmentation engine 130 analyzes the set of analyzed data using one or more sets of segmentation analytics to identify a set of characteristics associated with the user of mobile device 102. For example, segmentation engine 130 may identify a set of characteristics associated with the user of mobile device 102 from the set of analyzed data received from image/video analyzer 116 indicating the user of mobile device is a male in his early thirties, who has a particular interest in a professional sports team. Additionally the received set of analyzed data may also indicate the user of mobile device is active in outdoor recreational sports.

Segmentation engine 130 associates the user of mobile device 102 with one or more marketing segments using the set of characteristics as depicted in step 410. For example, segmentation engine 130 may associate the user of mobile device 102 with one or more specific products typically purchased by fans with a particular interest in the identified professional baseball team. Additionally segmentation engine 130 may associate the user of mobile device 102 with one or more specific products typically purchased by outdoor recreational enthusiasts.

In step 412, segmentation engine 130 sends data associating the user of the mobile device with the one or more marketing segments to an ecommerce retailer. For example, segmentation engine 130 may associate the user of mobile device 102 with one or more specific products that are currently on sale, or may be desirable to the user of mobile device 102. Segmentation engine 130 may then notify the user of mobile device 102 of the sale or particular items using emails, a pre-recorded phone message, a facsimile, and/or a text message to mobile device 102. In other example embodiments, segmentation engine 130 may transmit one or more specific ads of the products to retail application 114 and/or display the one or more specific ads using other applications executing on mobile device 102. For example, one or more specific ads may be displayed when the user of mobile device 102 uses a social media website or application.

In other example embodiments, segmentation engine 130 use GPS coordinates to display one or more specific ads for one or more marketing segments of the user of mobile device 102 when mobile device 102 is within a certain proximity, or distance from the ecommerce retail store. For example, when the user of mobile device 102 is traveling a route that will pass or come within a determined distance of the ecommerce retail store, segmentation engine 130 may notify the user of mobile device 102 of particular products that have been associated with the user of mobile device 102.

FIG. 5 depicts a block diagram, generally designated 500, of components of the server executing the segmentation engine, in an embodiment in accordance with the present invention. It should be appreciated that FIG. 5 provides only an illustration of one implementation and does not imply any limitations with regard to the environments in which different embodiments may be implemented. Many modifications to the depicted environment may be made.

Mobile device 102 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM) 514 and cache memory 516. In general, memory 506 can include any suitable volatile or non-volatile computer readable storage media.

Operating system 112, retail application 114, image/video analyzer 116 and image repository 118 are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices, including resources of network 120 and server 122. In these examples, communications unit 510 includes one or more network interface cards. Communications unit 510 may provide communications through the use of either or both physical and wireless communications links. Operating system 112, retail application 114, image/video analyzer 116 and image repository 118 may be downloaded to persistent storage 508 through communications unit 510.

I/O interface(s) 512 allows for input and output of data with other devices that may be connected to mobile device 102. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., operating system 112, retail application 114, image/video analyzer 116 and image repository 118, can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Definitions

“Present invention” does not create an absolute indication and/or implication that the described subject matter is covered by the initial set of claims, as filed, by any as-amended set of claims drafted during prosecution, and/or by the final set of claims allowed through patent prosecution and included in the issued patent. The term “present invention” is used to assist in indicating a portion or multiple portions of the disclosure that might possibly include an advancement or multiple advancements over the state of the art. This understanding of the term “present invention” and the indications and/or implications thereof are tentative and provisional and are subject to change during the course of patent prosecution as relevant information is developed and as the claims may be amended.

“Embodiment,” see the definition for “present invention.”

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “set of” items means there exists one or more items; there must exist at least one item, but there can also be two, three, or more items. A “subset of” items means there exists one or more items within a grouping of items that contain a common characteristic.

A “plurality of” items means there exists at more than one item; there must exist at least two items, but there can also be three, four, or more items.

“Includes” and any variants (e.g., including, include, etc.) means, unless explicitly noted otherwise, “includes, but is not necessarily limited to.”

A “user” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” acting as a single “user.”

The terms “receive,” “provide,” “send,” “input,” “output,” and “report” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

A “module” is any set of hardware, firmware, and/or software that operatively works to do a function, without regard to whether the module is: (i) in a single local proximity; (ii) distributed over a wide area; (iii) in a single proximity within a larger piece of software code; (iv) located within a single piece of software code; (v) located in a single storage device, memory, or medium; (vi) mechanically connected; (vii) electrically connected; and/or (viii) connected in data communication. A “sub-module” is a “module” within a “module.”

A “computer” is any device with significant data processing and/or machine readable instruction reading capabilities including, but not necessarily limited to: desktop computers; mainframe computers; laptop computers; field-programmable gate array (FPGA) based devices; smart phones; personal digital assistants (PDAs); body-mounted or inserted computers; embedded device style computers; and/or application-specific integrated circuit (ASIC) based devices.

“Automatically” means “without any human intervention.”

What is claimed is:

1. A computer-implemented method comprising:
receiving authorization from a mobile user to access one or more images and/or videos on a mobile device;
receiving image data including at least one of the one or more images and/or videos on the mobile device;
analyzing the image data using one or more image and/or video analyzers to identify a set of characteristics associated with the mobile user;
associating the mobile user with one or more marketing segments based, at least in part, on the identified set of characteristics; and
sending data associating the mobile user with the one or more marketing segments to an ecommerce retailer.

2. The computer-implemented method of claim 1, further comprising:
prompting the mobile user to capture one or more images and/or videos using a camera on the mobile device.

3. The computer-implemented method of claim 2, wherein prompting the mobile user includes providing a recommendation for what the mobile user should capture one or more images and/or videos of.

4. The computer-implemented method of claim 3, wherein the recommendation is a recommendation to capture one or more images and/or videos of a product the mobile user possesses in a category that the ecommerce retailer sells products in.

5. The computer-implemented method of claim 3, wherein the recommendation includes a recommendation to capture one or more images and/or videos that include the mobile user, the mobile user's friends, and/or the mobile user's family.

6. The computer-implemented method of claim 1, wherein the image data further includes one or more images and/or videos from a cloud storage account.

7. The computer-implemented method of claim 6, wherein analyzing the image data to identify a set of characteristics associated with the mobile user comprises determining that an image and/or video from the cloud storage account includes the mobile user based on tag information.

8. A computer program product comprising:
one or more computer readable storage media and program instructions stored on the one or more computer readable storage media, the program instructions comprising:
program instructions to receive authorization from a mobile user to access one or more images and/or videos on a mobile device;
program instructions to receive image data including at least one of the one or more images and/or videos on the mobile device;
program instructions to analyze the image data using one or more image and/or video analyzers to identify a set of characteristics associated with the mobile user;
program instructions to associate the mobile user with one or more marketing segments based, at least in part, on the identified set of characteristics; and
program instructions to send data associating the mobile user with the one or more marketing segments to an ecommerce retailer.

9. The computer program product of claim 8, further comprising:
program instructions to prompt the mobile user to capture one or more images and/or videos using a camera on the mobile device.

10. The computer program product of claim 9, wherein prompting the mobile user includes providing a recommendation for what the mobile user should capture one or more images and/or videos of.

11. The computer program product of claim 10, wherein the recommendation is a recommendation to capture one or more images and/or videos of a product the mobile user possesses in a category that the ecommerce retailer sells products in.

12. The computer program product of claim 10, wherein the recommendation includes a recommendation to capture one or more images and/or videos that include the mobile user, the mobile user's friends, and/or the mobile user's family.

13. The computer program product of claim 8, wherein the image data further includes one or more images and/or videos from a cloud storage account.

14. The computer program product of claim 13, wherein analyzing the image data to identify a set of characteristics associated with the mobile user comprises determining that an image and/or video from the cloud storage account includes the mobile user based on tag information.

15. A computer system comprising:
one or more computer processors;
one or more computer readable storage media;
program instructions stored on the computer readable storage media for execution by at least one of the one or more processors, the program instructions comprising:
program instructions to receive authorization from a mobile user to access one or more images and/or videos on a mobile device;
program instructions to receive image data including at least one of the one or more images and/or videos on the mobile device;
program instructions to analyze the image data using one or more image and/or video analyzers to identify a set of characteristics associated with the mobile user;
program instructions to associate the mobile user with one or more marketing segments based, at least in part, on the identified set of characteristics; and
program instructions to send data associating the mobile user with the one or more marketing segments to an ecommerce retailer.

16. The computer system of claim 15, further comprising:
program instructions to prompt the mobile user to capture one or more images and/or videos using a camera on the mobile device.

17. The computer system of claim 16, wherein prompting the mobile user includes providing a recommendation for what the mobile user should capture one or more images and/or videos of.

18. The computer system of claim 17, wherein the recommendation is a recommendation to capture one or more images and/or videos of a product the mobile user possesses in a category that the ecommerce retailer sells products in.

19. The computer system of claim 17, wherein the recommendation includes a recommendation to capture one or more images and/or videos that include the mobile user, the mobile user's friends, and/or the mobile user's family.

20. The computer system of claim 15, wherein the image data further includes one or more images and/or videos from a cloud storage account, and wherein analyzing the image data to identify a set of characteristics associated with the mobile user comprises determining that an image and/or video from the cloud storage account includes the mobile user based on tag information.
